(19) United States
(12) Patent Application Publication
(10) Pub. No.: US 2017/0249075 A1
(43) Pub. Date: Aug. 31, 2017

(54) Method of switching data between windows in real-time on an intelligent terminal

(71) Applicant: Maoxiao PENG, Beijing (CN)

(72) Inventor: Maoxiao PENG, Beijing (CN)

(21) Appl. No.: 15/152,510

(22) Filed: May 11, 2016

(30) Foreign Application Priority Data
Feb. 26, 2016 (CN) 201610104157.8

(51) Int. Cl. G06F 3/0484; H04L 12/58; G06F 3/0481

(52) U.S. Cl. CPC G06F 3/04845; G06F 3/04842; G06F 3/0481; H04L 51/24; H04L 51/046; G06F 2203/04806

(57) ABSTRACT

The present invention discloses a method of switching data between windows in real-time on an intelligent terminal, which includes: when a trigger condition is met, an original page which is the present page is zoomed out and turned into a first zoomed-out window and a second page becomes the present page, while the data in the first zoomed-out window will be synchronized; when the first zoomed-out window is clicked, the first zoomed-out window is zoomed in, and the second page is zoomed out and turned into a second zoomed-out window, wherein when a switch does not occur between the pages, the data on these pages is seamless switched. The seamless switch between pages is implemented. When a user watches videos, plays games, listens music, views external links or chats on video, the user can zoom out the present window, and drag the zoomed-out window to any page which is the present page, thereby implementing multiple pages running simultaneously. The existing software cannot implement the real-time switch between two windows. According to the present invention, when a page is zoomed out to become a zoomed-out window, the data will be synchronized, that is, the data in the zoomed-out window will be synchronized to the present page; when the zoomed-out window is clicked, the zoomed-out window will be zoomed in to fit the full screen, and the present page will be zoomed out to become a zoomed-out window and the data in the zoomed-out window will be synchronized to the present page.

### CROSS REFERENCE TO RELATED APPLICATIONS

Applicant claims priority under 35 U.S.C. 119 from Chinese application CN 201610104157.8 filed on Feb. 25, 2016 the disclosure of which is hereby incorporated herein by reference in its entirety.

### TECHNICAL FIELD

The present invention relates to the data conversion technical field, and more specifically, to a method of switching data between windows in real-time on an intelligent terminal.

### BACKGROUND

For existing mobile APPs, data conversion modes in these APPs have been made little change for a long time. When a user uses these APPs, the user has to repeatedly do the actions of return, enter, and then return, and then enter. In such modes, it is inconvenient for the user to use the software and it will waste a lot of time. Take the WeChat as an example, suppose that a user is watching a video shared on the Moments while a message from a friend is received, when the user clicks the message, the video will be terminated. That is, the user cannot simultaneously watch the video and view the message on one intelligent terminal. This results in a poor user experience because the user has to waste a lot of time on the operation of the software. Poor user experience then results in fewer users to use the APP.

As above, when a user uses the existing APPs, the user will spend a lot of time on the actions such as return, enter, exit, and so on, and this will result in fewer users to use the APP.

### SUMMARY OF THE INVENTION

The present invention aims at providing a method of switching data between windows in real-time on an intelligent terminal, in order to overcome the issues of wasting a lot of time and loss of users which are resulted from repeatedly actions of return, enter, exit, and so on.

According to the present invention, a method of switching data between windows in real-time on an intelligent terminal is provided, wherein when a trigger condition is met, an original page which is the present page is zoomed out and turned into a first zoomed-out window and a second page becomes the present page, while the data in the first zoomed-out window still be synchronized; when the first zoomed-out window is clicked, the first zoomed-out window is zoomed in, and the second page is zoomed out and turned into a second zoomed-out window, wherein when a switch does not occur between the pages, the data on these pages is seamless switched.

The existing software cannot make a real-time data switch between two windows. According to the method of switching data between windows in real-time on an intelligent terminal provided in the present invention, when a page is zoomed out to turn into a zoomed-out window, the data on this page can be synchronized and then the data in the zoomed-out window can be switched into the present page. That is, when the zoomed-out window is clicked, the zoomed-out window will be zoomed in to fit the full screen, and the previous page will be zoomed out to turn into a zoomed-out window, and the data in the zoomed-out window can be switched into the present page in real-time.

### BRIEF DESCRIPTIONS OF THE DRAWINGS

FIG. 1 illustrates a flow chart of a method of switching data between windows in real time on an intelligent terminal according to the present invention; and

FIG. 2 shows an alternative embodiment.

### DETAILED DESCRIPTION OF THE EMBODIMENTS

In order to make the objects, technical solutions and advantages of the present invention more clearly, the present invention will be described in details by reference to the embodiments. It should be understood that, the specifically embodiments described herein are intended to explain the present invention only, and not to limit the present invention.

The present invention may be implemented as follows: when a trigger condition is met, an original page which is the present page is zoomed out and turned into a first zoomed-out window and a second page becomes the present page, while the data in the first zoomed-out window still be synchronized; when the first zoomed-out window is clicked, the first zoomed-out window is zoomed in, and the second page is zoomed out and turned into a second zoomed-out window, wherein when a switch does not occur between the pages, the data on these pages is seamless switched.

According to one embodiment of the present invention, firstly, a window zoom-out button should be added on a page which will be zoomed out later; based on software programming method which uses codes, the present page is zoomed out to decrease in proper size; implement the basic functions of the zoomed-out window and make the zoomed-out window enable to be dragged to anywhere on the screen; and implement a switch between any two pages.

Hereinafter, the principle of the present invention will be further described in conjunction with the drawings.

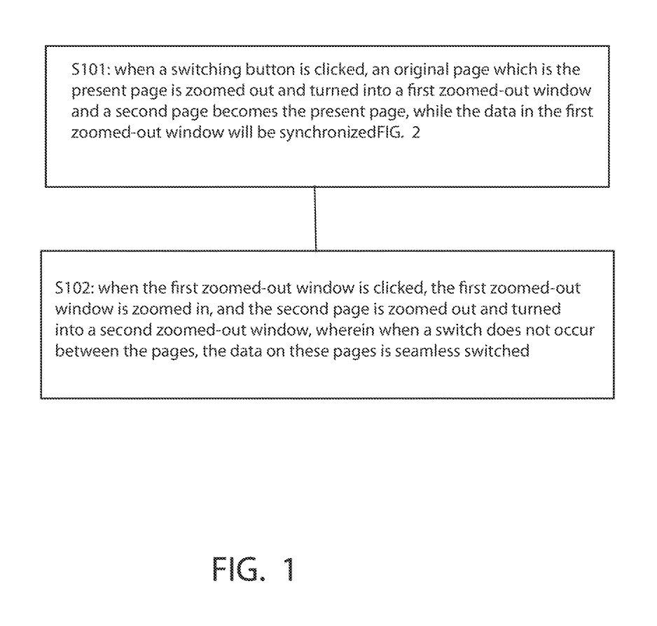

As shown in FIG. 1, the method of switching data between windows in real time on an intelligent terminal according to the present invention includes the following steps.

S101: when a switching button is clicked, an original page which is the present page is zoomed out and turned into a first zoomed-out window and a second page becomes the present page, while the data in the first zoomed-out window will be synchronized;

S102: when the first zoomed-out window is clicked, the first zoomed-out window is zoomed in, and the second page is zoomed out and turned into a second zoomed-out window, wherein when a switch does not occur between the pages, the data on these pages is seamless switched.

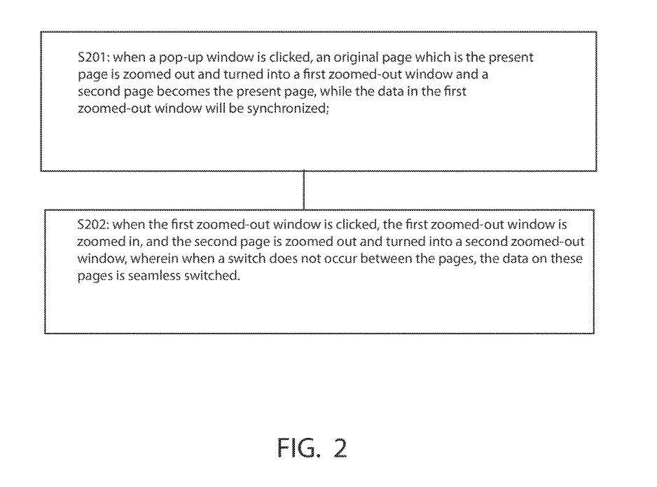

According to another embodiment of the present invention, as shown in FIG. 2 it does not need to add a switching button, but it needs to pop-up a zoomed-out window on the current window page to show that a new message is received. The zoomed-out window may be located on anywhere on the current window. In this embodiment, the method of switching data between windows in real time on an intelligent terminal according to the present invention includes the following steps.

S201: when a pop-up window is clicked, an original page which is the present page is zoomed out and turned into a first zoomed-out window and a second page becomes the present page, while the data in the first zoomed-out window will be synchronized;

S202: when the first zoomed-out window is clicked, the first zoomed-out window is zoomed in, and the second page is zoomed out and turned into a second zoomed-out window, wherein when a switch does not occur between the pages, the data on these pages is seamless switched.

According to the present invention, the data can be synchronously switched. When a switching button or a pop-up window is clicked, an original page which is the present page is zoomed out and turned into a first zoomed-out window and a second page becomes the present page, while the data in the first zoomed-out window will be synchronized; when the first zoomed-out window is clicked, the first zoomed-out window is zoomed in, and the second page is zoomed out and turned into a second zoomed-out window, wherein when a switch does not occur between the pages, the data on these pages is seamless switched.

The above descriptions only show the prefer embodiment of the present invention, and are not used to limit the present invention. Many modifications, equivalents and improvements which are made without departing from the spirit and scope of the system should be covered by the protection scope of the present invention.

### FIGURES

FIG. 1
S101: when a switching button is clicked, an original page which is the present page is zoomed out and turned into a first zoomed-out window and a second page becomes the present page, while the data in the first zoomed-out window will be synchronized
S102: when the first zoomed-out window is clicked, the first zoomed-out window is zoomed in, and the second page is zoomed out and turned into a second zoomed-out window, wherein when a switch does not occur between the pages, the data on these pages is seamless switched

1. A method of switching data between windows in real-time on an intelligent terminal, comprising the following steps:
zooming out when a trigger condition is met, an original page, which is the present page and turned into a first zoomed-out window and wherein a second page becomes the present page,
synchronizing the data in the first zoomed-out window; when the first zoomed-out window is clicked, wherein the first zoomed-out window is zoomed in, and the second page is zoomed out and turned into a second zoomed-out window, wherein when a switch does not occur between the pages, the data on these pages is seamlessly switched.

2. The method of claim 1, wherein, the method further comprises: presetting a switching button on a page to be zoomed out.

3. The method of claim 2, wherein, the trigger condition is that the switching button is clicked.

4. The method of claim 1, wherein, the method further comprises: showing a pop-up zoomed-out window on the current page when a message is received.

5. The method of claim 4, wherein, the trigger condition is that the pop-up zoomed-out window is clicked.
